(19) United States
(12) Patent Application Publication
(10) Pub. No.: US 2012/0066043 A1
(43) Pub. Date: Mar. 15, 2012

(54) Mobile Gift Card

(76) Inventors: Chris Carmichael, Laguna Niguel, CA (US); Connie Jordan, Laguna Niguel, CA (US)

(21) Appl. No.: 13/221,309

(22) Filed: Aug. 30, 2011

Related U.S. Application Data
(60) Provisional application No. 61/382,337, filed on Sep. 13, 2010.

(51) Int. Cl. G06Q 20/28; G06Q 30/02

(52) U.S. Cl. 705/14.23; 705/44

(57) ABSTRACT

A gift card that automatically updates its balance and allows storing purchased items.

### BACKGROUND

Gift cards have conventionally been given to allow a user to buy an item at a bricks and mortar store. Gift cards are often used in electronic operations, where a gift card can allow purchases on an electronic site, usually based on numbers read off the gift card and entered into the site.

### SUMMARY

Embodiments describe a virtual gift card system operable on a computer that has a wireless capability, and having a display screen. The display screen showing a virtual gift card that allows purchases, said virtual gift card showing a code that is uniquely indicative of a specific gift card, and showing a balance, said computer connecting to a remote server, which validates information about said gift card, and updates said balance, and where said code can be used by another computer that reads said code to access said server in order to make a purchase.

After accessing said server to make said purchase, the balance is can be automatically updated to include an amount was purchased.

The computer can determine a location and use that location as part of said making the purchase. A user can automatically receive rewards points for making said purchase.

### BRIEF DESCRIPTION OF THE DRAWINGS

FIG. 1 shows the hardware of the mobile gift card and a flowchart of its operation.

### DETAILED DESCRIPTION

Our patent application Ser. No. 11/782, 448 describes a special coupon system that can be used in an electronic environment. Our issued U.S. Pat. No. 7,588,180, the entire contents of which are herewith incorporated by reference, describes a card that can be used for location tracking and currency exchange.

The present application describes a mobile gift card that can be used in conjunction with this special coupon system and/or can be used on this special card.

In one embodiment, the mobile gift card is a mobile web downloadable application that allows users to purchase and send gift cards that operate similar to the current gift cards on the market. The user of the mobile gift card can make purchases both on and off line using the card. The amounts of the purchases are then deducted from the card as the purchases are made.

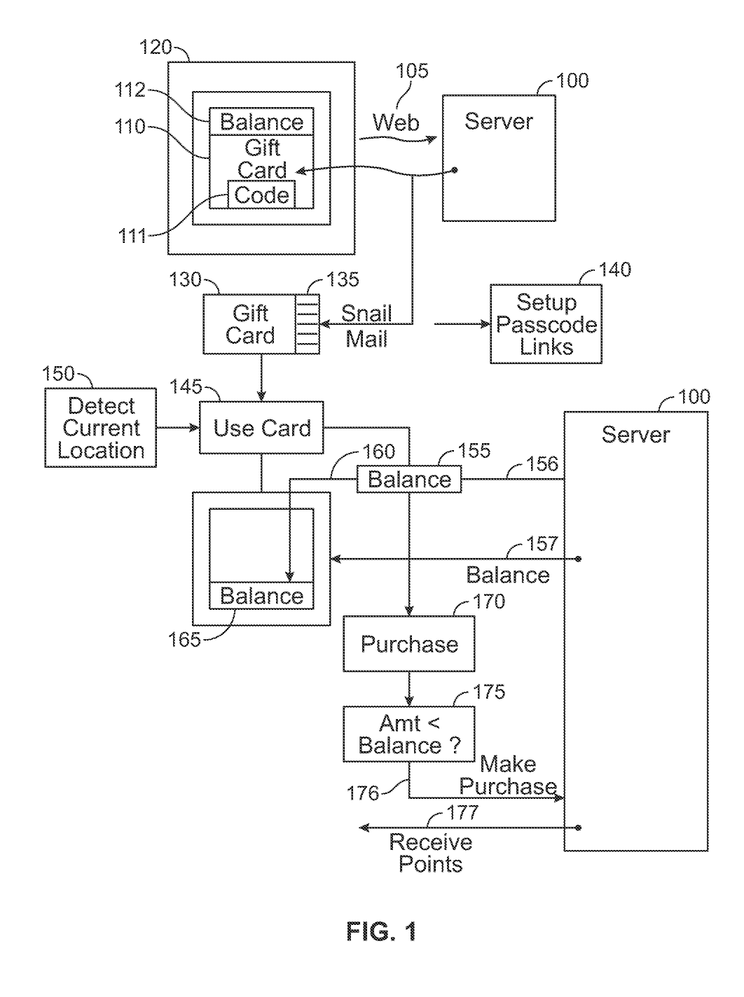

According to an embodiment, shown in FIG. 1, the user can access the server 100 via a web connection 105. The axis of the server accesses a program that returns information about the gift card 110. In one embodiment, the server is being accessed from a portable phone or tablet 120. The gift card 110 is returned to the tablet as a facsimile of the card, which includes certain information thereon, and an optically readable code 111 such as a barcode. That code is uniquely indicative of a specific gift card and readable to represent the card. Either in addition for or alternatively, the server may return a physical card 130 via snail mail. The physical card may be electronic, and may have a connector 135 thereon. Once the user receives the card, either the virtual card for the real card, at 140, the user can set up their pass code and links to various reward agencies.

The card becomes a virtual card where a part 135 can be inserted into the computer to facilitate the purchase, and numbers and/or other identifiers read from the card. This may also use the techniques described in our U.S. Pat. No. 7,588,180, where the mobile gift card information can be on a multiple purpose card of a type that allows operations other than gift card operations including determining a location from which the gift card is being used. When using the virtual card, the user can either scan the code 111 directly from the card and/or use wireless communication from the communicator 120. In one embodiment, the communicator is a tablet or a cellular phone, and the operations described herein become a mobile application.

The card can include a balance 112, which is the amount left on the card that can be used. This may be returned from the server on request, and/or stored in the card and updated from the server. If the gift card 130 is an electronic card, its display can also be used to display the balance. In another embodiment, the balance can be looked up based on the identifier that is read directly from the card.

Once the gift card balance is reached, the gift card is invalidated, or replenished at the option of the user or the purchaser.

This card also allows collecting points at the same time when used. The purchases may also be tied to purchase points from an underwriting financial organization or retailer. Similar to the world smart card, the gift card purchases require a simple set up by the recipient of the card and a pass code both of which are carried out as part of step 140. Notifications of the purchases are sent to the recipient's email to provide both a receipt and for security purposes. Special encryption allows for both card security and mobile device use. Moreover, since the information on the card is directly read, more complicated codes can be used as compared with cards that require a user to read information off the card.

At 145, the user uses the card. This may include detecting the user's current location at 150, which can be done in the card using the techniques described in the world smart card; or can be done using the location detection on the tablet or communicator 120. If the user requests a balance at 155, at balance request is sent to the server 100 at 156, and the balance is then returned at 157 to be shown on the card 165 in another embodiment, the balance may be automatically updated whenever there is a server communication transaction. If the user desires to make a purchase at 170, the system determines at 175 if the amount is less than the balance. If so, the purchase is allowed at 176, and the information is sent to the server 100. The server controls receiving points at 177, reducing the balance, and updating the card.

In this way, the code can be read by another computer, for example point-of-sale computer store, and used to make a purchase. The making of the purchase comprises the store computer validating the gift card, and also validating that there is enough money on the gift card. Once this is done, the purchase is allowed to proceed, and then the server, at its next opportunity, adjusts the balance that is used on the gift card.

Other embodiments are contemplated. For example, the above has described one particular application, but this can be used for many different applications. These applications may use the card as a gift card, where the card is prepaid, and also as a credit card, where user may have a certain amount of credit line available, and the system may treat the credit line as though it were a gift amount.

One application includes using the mobile gift card to obtain mobile coupons. In this embodiment, the user can use the card to pay for purchases, but can also use the card to download different coupons that provide different discounts off of these purchases. For example, the user may see coupons while online, and download these coupons, two story than either immediately or later on the mobile gift card. The coupons may be shown on the display screen, and also stored electronically on the device. In one embodiment, the menu actuation may allow searching for or sequentially viewing all of the different coupons which are available on the card. Any time the card is used at a vendor who honors the coupon, the coupon can be automatically electronically downloaded and used as part of the purchase.

Another embodiment describes using this system for mobile ticketing for concerts, sporting events, movie, or travel. In this embodiment, the card can be used to purchase items such as a ticket for one of these things. Once purchasing the ticket, the ticket is electronically encoded into the card, so that the coded card becomes the ticket. Often when electronic tickets are used, the issuer wants the user to have the form of payment at the same time that they use the purchased ticket. For example, a user who purchases a plane ticket might be asked to have the credit card available. By using the same card for both purchasing the item and storing the item, the form of payment becomes automatically available when the ticket is used.

This card can also be used to accumulate rewards points, such as “Ralph's rewards”, so that any time the device is used at a particular store, rewards points for that store are automatically accumulated either on the card or on an account associated with the card. In one embodiment, use of the card may provide more rewards than would be otherwise accumulated into the user's account, in order to even further reward users who use this card. In a similar way, this can be done for membership cards to hotels, mobile affinities, wholesale stores like Costco, and any other membership.

Another embodiment provides mobile rewards, which may automatically provide suggestions to a user based on determining their location.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of payment cards and devices can be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A virtual purchase card system operable on a computer, comprising:
a computer, having a wireless capability, and having a display screen,
said display screen showing a virtual purchase card that allows purchases, said virtual purchase card showing a code that is uniquely indicative of a specific purchase card, and showing a balance,
said computer connecting to a remote server, and sending information indicative of the virtual purchase card to the remote server, and receiving validation information about said purchase card, and updated balance information from the remote server, and where said code can be used by another computer that reads said code to access said server in order to make a purchase.

2. A system as in claim 1, wherein after accessing said server to make said purchase, the balance is automatically updated to include an amount that said purchase.

3. A system as in claim 1, further comprising said computer determining a location and using said location as part of said making said purchase.

4. A system as in claim 1, further comprising automatically receiving rewards points for making said purchase.

5. A system as in claim 1, wherein said purchase is a purchase of a ticket, and said ticket is stored electronically on said card so that the card becomes the ticket.

6. A system as in claim 1, wherein said purchase card is a prepaid purchase card.

7. A method of using a computer based device for making a purchase, comprising:
on a computer with a wireless capability and a display screen, showing a virtual purchase card that allows purchases, said virtual purchase card showing a code that is uniquely indicative of a specific purchase card, and showing a balance on said display screen,
connecting to a remote server, and receiving validation information about said purchase card, and updated balance information,
and where said code can be used by another computer that reads said code to access said server in order to make a purchase.

8. A system as in claim 7, wherein after accessing said server to make said purchase, the balance is automatically updated to include an amount that said purchase.

9. A system as in claim 7, further comprising said computer determining a location and using said location as part of said making said purchase.

10. A system as in claim 7, further comprising automatically receiving rewards points for making said purchase.

11. A system as in claim 7, wherein said purchase is a purchase of a ticket, and said ticket is stored electronically on said card so that the card becomes the ticket.

12. A system as in claim 7, wherein said purchase card is a prepaid purchase card.

13. A virtual gift card system operable on a computer, comprising:
a computer, having a wireless capability, and having a display screen,
said display screen showing a virtual purchase card that allows purchases, said virtual purchase card showing a code that is uniquely indicative of a specific card,
said computer connecting to a remote server, which validates information about said purchase card, and allows purchasing a ticket, and stores information about said ticket electronically on said card along with said code, so that the card becomes the ticket and is also the form of payment for the ticket.
